(19) United States
(12) Patent Application Publication
(10) Pub. No.: US 2011/0150073 A1
(43) Pub. Date: Jun. 23, 2011

(54) SCALABLE VIDEO TRANSCODING DEVICE

(75) Inventor: Ajay Luthra, San Diego, CA (US)

(73) Assignee: GENERAL INSTRUMENT CORPORATION, Horsham, PA (US)

(21) Appl. No.: 12/643,252

(22) Filed: Dec. 21, 2009

(51) Int. Cl. H04N 7/24

(52) U.S. Cl. 375/240.02; 375/E07.013

(57) ABSTRACT

A transcoding device is configured to transcode a scalable video coded stream to a single layer encoded video stream for a receiving device. The transcoding device includes an interface connecting the receiving device to the transcoding device, and a transcoder. The transcoder receives the scalable video coded stream via the interface from the receiving device in response to the receiving device determining the encoded video stream includes the scalable video coded stream. The transcoder generates a single layer encoded video stream from the scalable video coded stream based on coding parameters describing a single layer encoded video stream to be generated by the transcoder. The transcoding device sends the single layer encoded video stream to the receiving device via the interface.

### BACKGROUND

Traditionally, content is delivered to a subscriber in an encoded format, such as television programs transmitted in an encoded video stream to a subscriber's set-top box (STB) via a cable network. Then, the content is decoded at the STB and sent to a TV to be viewed. There is an increasing interest in using scalable video coding to encode and deliver content to subscribers for viewing.

Scalable video coding is described in the MPEG-4 AVC video compression standard and is known technique for encoding video. Scalable video coding allows compression of video in multiple layers such that the quality of the decoded video is improved as more layers are used to decode the video. Scalable video coding can be used to accommodate STBs having different capabilities. As an example, assume STBs are deployed that have different decoding capabilities. Some may have the ability to decode video at the highest resolution and bit rate and some may not.

One solution would be to deliver different video streams to accommodate different capabilities of the deployed STBs, such as one video stream carrying video having a 720 p resolution and having a lower bit rate, and another stream carrying the same video but having a 1080 p resolution and having a higher bit rate. However, the requirement of sending multiple streams carrying the same content ultimately consumes more bandwidth in the network. Another solution is to use scalable video coding. In this solution, a transmitter can send a scalable video coded stream to all the receiving devices. Then, lower-capability STBs may only use the base layer of the scalable video coded stream while other STBS can additionally utilize one or more enhancement layers in the scalable video coded stream to generate the highest quality video.

Even though scalable video coding appears to be a highly satisfactory solution for providing the highest quality video to all subscribers, one of the key problems is that legacy decoders in STBs do not have the capability to decode a scalable video coded stream. Therefore, for subscribers to be able to take advantage of scalable video coding, the STBs at all the subscriber premises would have to be replaced or the STBs would have to be upgraded with new hardware that is capable of decoding scalable video coded streams. This is expensive and is also not easy to do.

### SUMMARY

According to an embodiment, a transcoding device is connectable to a receiving device, such as a STB or other type or receiving device configured to receive an encoded scalable video stream. A decoder in the receiving device may not have the capability to decode the scalable video coded stream. The transcoding device may receive the scalable video coded stream from the receiving device and transcode the scalable video coded stream into a format that is decodable by the receiving device. The transcoding performed by the transcoding device may include decoding the scalable video coded stream and re-encoding the scalable video coded stream into a single layer encoded video stream that is decodable by the receiving device.

The transcoding device allows an existing STB or other type of receiving device to provide users with the ability to view content delivered in an scalable video coded stream even when the STB does not have the capability to decode the scalable video coded stream. Therefore, there is no need to upgrade the existing STB or provide a new STB that supports scalable video coding. Furthermore, the users can take advantage of improved video quality that is made possible through scalable video coding but otherwise may not be available because of bandwidth or device limitations.

### BRIEF DESCRIPTION OF THE DRAWINGS

Features of the present invention will become apparent to those skilled in the art from the following description with reference to the figures, in which:

FIG. 1 shows a system, according to an embodiment;

FIG. 2 shows a receiving device and a transcoding device, according to an embodiment;

FIG. 3 shows a receiving device and a decoding device, according to an embodiment;

FIG. 4 shows a flowchart of a method performed by a receiving device, according to an embodiment; and

FIG. 5 shows a flowchart of a method performed by a transcoding device, according to an embodiment.

### DETAILED DESCRIPTION

For simplicity and illustrative purposes, the present invention is described by referring mainly to exemplary embodiments. In the following description, numerous specific details are set forth to provide a thorough understanding of the embodiments. However, it will be apparent to one of ordinary skill in the art that the present invention may be practiced without limitation to these specific details. In other instances, well known methods and structures have not been described in detail to avoid unnecessarily obscuring the description of the embodiments. Also, two or more of the embodiments described herein may be used in combination with each other.

According to an embodiment, a transcoding device is connectable to a receiving device, such as a STB or other device. The transcoding device may be a device that is external to the receiving device but is connectable to the receiving device through an interface, such as a universal serial bus (USB) port, Ethernet port, or other known wired or wireless interfaces. The transcoding device is configured to receive a scalable video coded stream from the receiving device via the interface along with a control signal from the receiving device. The transcoding device generates a single layer encoded video stream from the scalable video coded stream using coding parameters provided in the control signal. The encoding parameters may identify a coding standard (e.g., MPEG-2, MPEG-4 AVC, etc.), a resolution (e.g., 720 p, 1080 p, etc.) or other parameters for the single layer encoded video stream to be generated by the transcoding device from the scalable video coded stream. The single layer encoded video stream generated by the transcoding device is sent back the receiving device, for example, through the same interface, whereby the stream may be decoded by the receiving device.

Note that “encoding” and “coding” as used herein refers to encoding a video stream using a predetermined compression standard (e.g., an MPEG standard). Also, a single layer encoded video stream is a traditional encoded video stream that includes only one stream that is decodable by a decoder to generate the decoded video stream. A scalable video coded stream is a multi-layer encoded video stream that includes a base layer and one or more enhancement layers. The base layer includes a video stream having a particular spatial or temporal resolution. The base layer may be decoded as a single layer encoded video stream. The base layer may have a spatial or temporal resolution or a quality that is lower than the bitstream it was originally derived from. The one or more enhancement layers include video data that is used to reconstruct a video stream having a higher spatial resolution, temporal resolution, and/or quality than the base layer. Generally, the scalable video coded stream is scalable because one or more substreams (i.e., enhancement layers) in the stream may be used by a target decoder to generate a decoded video stream. If all the layers are not used to decode the video, it results in a lower quality video. A single layer encoded video stream only includes one layer and is not scalable.

Scalable video coding and reconstructing a scalable video coded stream to generate a single layer encoded video stream is known in the art. “Overview of the Scalable Video Coding Extension of the H.264/AVC Standard” by Schwarz et al, IEEE Transactions on Circuits and Systems for Video Technology, Vol. 17, No. 9, September 2007, describes scalable video coding and is incorporated by reference in its entirety.

Also, according to one embodiment, the transcoding device is configured to output a single layer MPEG encoded stream, such as MPEG-2 or MPEG-4 AVC. Legacy STBs or other legacy receiving devices may only have the capability to decode an MPEG-2 or MPEG-4 AVC stream. In this embodiment, the transcoding device generates a single layer MPEG encoded stream, such as an MPEG-2 or MPEG-4 AVC stream, that the legacy receiving device is able to decode. In another implementation, non-MPEG streams may be generated in compliance to other video standards such as VC-1 (SMPTE).

### 1. System

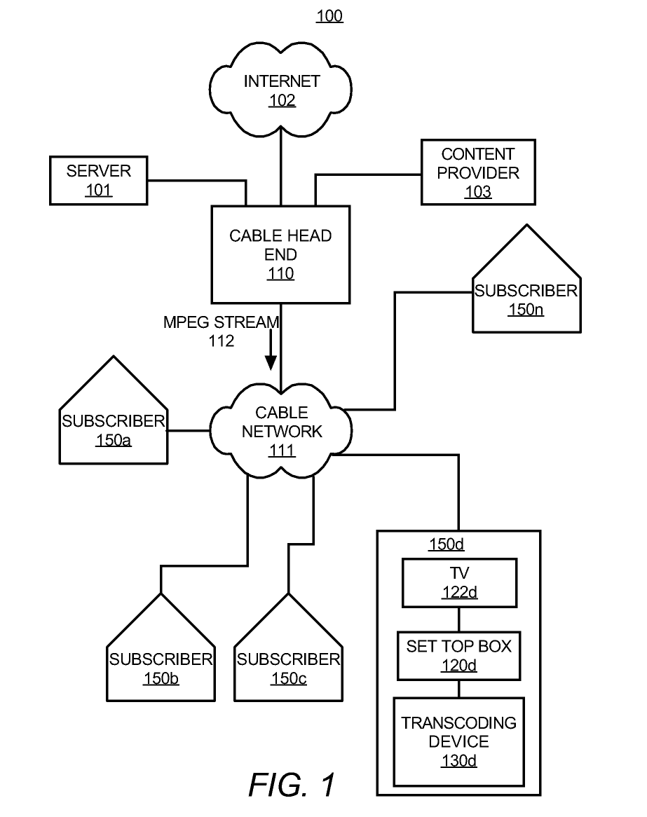

FIG. 1 illustrates a system 100, according an embodiment, whereby the transcoding device may be deployed. The system 100 includes cable television network architecture by way of example, and it will be apparent to one of ordinary skill in the art that the transcoding device may be used in other types of systems and networks, including satellite systems or other networks.

A number of data sources may be communicatively coupled to a distribution node 110, such as a CO, cable head-end, hub, etc., to deliver content for distribution to subscribers. By way of example, the data sources include servers 101, the Internet 102, and content provider 103 for example providing video or other types of content. The distribution node 110 is also communicatively coupled to one or more subscribers 150a-n through a cable network 111 or any other type of communications network.

The cable network 111 provides an MPEG stream 112 to each of the subscribers 150a-n using, for example, fixed optical fibers and/or coaxial cables. By way of example, the MPEG stream 112 may be a quadrature amplitude modulated (QAM) stream, or a real-time transport protocol (RTP) stream comprised of packetized data. The MPEG stream 112 may include data from the content provider 103 and/or other data sources. Each of the subscribers 150a-n may receive the MPEG stream 112 at a receiving device at their premises. The receiving device may be a STB connected to a TV or some other receiving device.

As shown in FIG. 1, the receiving device for the subscriber 150d includes STB 120d connected to TV 122d. The subscriber 150n may receive the MPEG stream 112 at the STB 120d. If, for example, the MPEG stream is a QAM stream, the STB 120d may thereafter select a frequency and demodulate the stream transmitted at the frequency to obtain a multi program transport stream (MPTS). Further, the cable network 111 is configured to provide a plurality of programs multiplexed together in the MPTS. The STB 120d is configured to demultiplex the MPTS to extract a single program stream corresponding to each of the plurality of programs which a subscriber may select. Each single program stream may be a scalable video coded stream. An RTP MPEG stream may also include multiple program streams multiplexed into a single stream. In this case, the RTP would be demultiplexed to extract a single program stream corresponding to each of the plurality of programs, and each single program stream may be a scalable video coded stream.

The subscriber 150d may use the STB 120d to select a program from a single program stream. If the single program stream is a scalable video coded stream, the STB 120d may not have the capability to decode the stream to provide the selected program. The STB 120d sends the scalable video coded stream to transcoding device 130d, and the transcoding device 130d transcodes the scalable video coded stream to a single layer encoded video stream that can be decoded by the STB 120d and then displayed on the TV 122d. Although not shown, the other subscribers may also include a STB, transcoding device, and TV or other user devices.

### 2. Receiving Device and Transcoding or Decoding Device

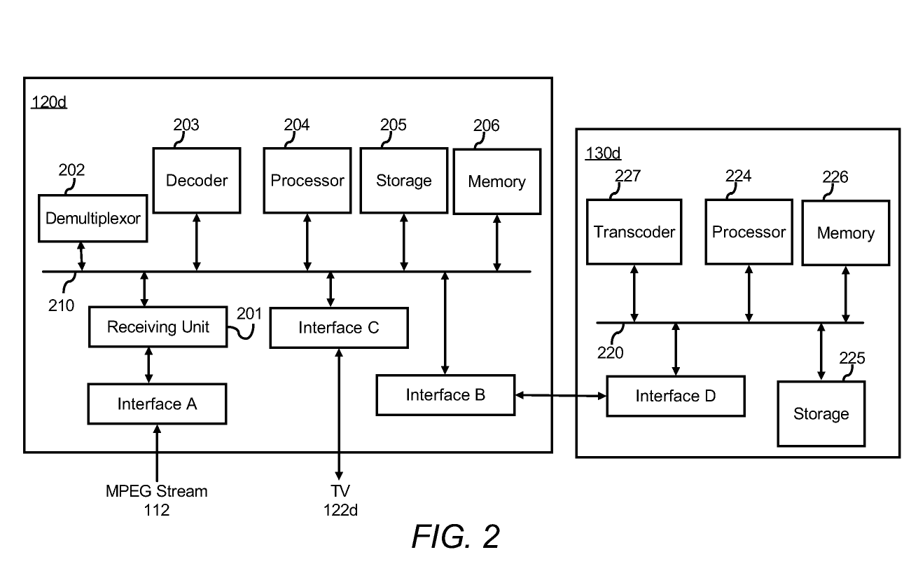

FIG. 2 illustrates a block diagram of a receiving device and a transcoding device, according to an embodiment, both of which may be provided in one or more of the subscriber premises of FIG. 1. In FIG. 2, the receiving device, for example, is the STB 120d, and the transcoding device is the transcoding device 130d shown in FIG. 1.

The STB 120d may include interfaces A-C, receiving unit 201, demultiplexor 202, decoder 203, processor 204, storage 205, and memory 206 connected via system bus 210. It will be apparent to one of ordinary skill in the art the STB 120d may include more or less components than shown, and the components shown are merely to illustrate basic functionality of the STB 120d.

The MPEG stream 112 is received via an interface A. The interface A may include a coaxial connection, a fiber optic connection, etc. The receiving unit 201 may include a tuner/demodulator demodulating the received MPEG stream 112. A demultiplexor 202 demultiplexes the received MPEG stream 112 to produce one or more single program streams.

The processor 204 performs syntax processing on the input stream (e.g., MPEG stream 112) to determine whether the input stream is a scalable video coded stream. For example, the input stream may include one or more flags in predetermined locations of a header or in other predetermined locations. The flags identify the stream as being a scalable video coded stream or some other type of stream. If the input stream is a scalable video coded stream, the processor 204 sends the stream to the transcoding device 110 via interface B. Interface B may include a USB interface, Ethernet interface, etc. If the input stream is an MPEG stream that is decodable by the decoder 203, the processor 204 sends the stream to the decoder 203. The decoded stream may be sent to the TV 122d via interface C, which may by a high-definition multimedia interface (HDMI) interface or another conventional audio/video interface.

The data storage 205 may include a hard drive or other non-volatile data storage storing video or other data. The memory 206 may include RAM. The data storage 205 and memory 206 are examples of computer readable storage devices that may store computer code executed by the processor 204 to perform various functions described herein.

The transcoding device 130d includes interface D, processor 224, data storage 225, memory 226, transcoder 227, and bus 220. It will be apparent to one of ordinary skill in the art that the transcoding device 130d may include more or less components than shown, and the components shown are merely to illustrate basic functionality of the transcoding device 130d.

The scalable video coded stream is received from the STB 120 via interface D, which may include a USB interface, Ethernet interface, etc. The processor 224 sends the scalable video coded stream to the transcoder 227 and also sends coding parameters for transcoding the scalable video coded stream into a single layer encoded video stream. The coding parameters may indicate a level of quality, a resolution (e.g., 720 P, 1080 P, etc.), a coding standard (e.g., MPEG-2, MPEG-4 AVC, etc.), and other parameters that describe the single layer encoded video stream to be generated by the transcoder 227. The transcoder constructs the single layer encoded video stream from the base layer and possibly one or more enhancement layers to have the quality, resolution, etc., specified by the coding parameters. The transcoder 227 also generates in the single layer encoded video stream in the encoding standard specified by the coding parameters. This may include converting the scalable video coded stream, for example, from MPEG-2 to MPEG-4 AVC.

The processor 204 in the STB 120d may send a control signal identifying the coding parameters to the processor 224 in the transcoding device 130d, or the coding parameters may have been previously stored in the transcoding device 130d. The coding parameters may reflect the type of stream that the decoder 203 in the STB 120d has the capability to decode. Also, the coding parameters may be modified to generate video of different qualities, resolutions, etc.

The single layer encoded video stream generated by the transcoder 227 is sent to the STB 120d via the interface D. The decoder 203 in the STB 120d decodes the single layer encoded video stream, which may then be sent to the TV 122d via interface C.

The data storage 225 may include non-volatile data storage, and the memory 226 may include RAM or some other type of storage. The data storage 225 and memory 226 are examples of computer readable storage devices that may store computer code executed by the processor 224 to perform various functions described herein.

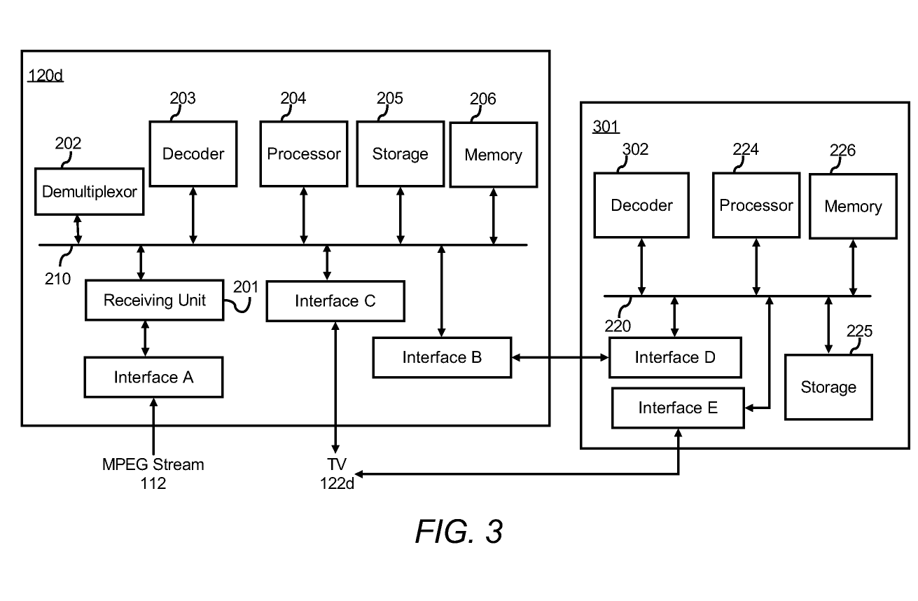

FIG. 3 illustrates a block diagram of a receiving device and a decoding device, according to another embodiment, both of which may be provided in one or more of the subscriber premises of FIG. 1. This embodiment is similar to the embodiment shown in FIG. 2, except a decoding device 301 is used instead of the transcoding device 130d. The decoding device 301 includes a decoder 302. The scalable video coded signal is received from the STB 120d via the interface B, the same as discussed with respect to FIG. 2. However, instead of generating a single layer encoded video stream, the decoder 302 decodes the scalable video coded signal, and the decoded video stream may be sent to the TV 122d via an interface E in the decoding device 301, or the decoded video stream may be sent to the STB 120d via interface B. The scalable video coded stream is decoded based on the coding parameters to generate a decoded video stream having the parameters specified by the coding parameters. Then, the STB 120d may send the decoded video stream to the TV or another device via an interface.

The transcoding device 130d and the decoding device 301 may be portable devices that are external to the STB 120d but connectable via the interface B. For example, the transcoding device 130d may be a device having its own housing that is external and separate from a housing of the STB 120d. The decoding device 301 may similarly have its own housing that is external and separate from the housing of the STB 120d. Thus, these devices may be easily distributed to the subscribers and the subscribers can connect the devices to their STBs without requiring a technician to be dispatched to the subscribers' premises. Then, the legacy STBs at the subscribers' premises can utilize scalable video coded streams even if their STBs do not have the capability to decode scalable video coded streams.

### 3. Methods

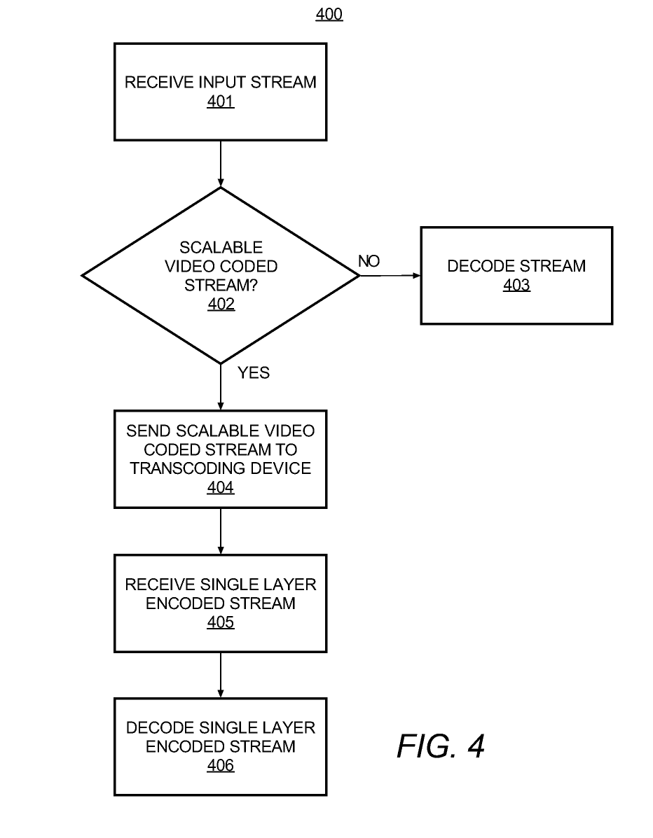

FIG. 4 illustrates a method 400 performed by a receiving device, according to an embodiment. The method 400 may be described with respect to FIGS. 1-3 by way of example and not limitation.

At step 401, the receiving device receives an input stream, for example, from a cable network or some other network. The input stream may be the MPEG stream 112 described above. The receiving device may be the STB 120d shown in FIGS. 1-3 or some other type of receiver.

At step 402, the receiving device determines whether the input stream includes a scalable video coded stream. For example, the processor 204 shown in FIGS. 2 and 3 of the STB 120 determines whether any flags in the received MPEG stream 112 identify the stream as a scalable video coded stream.

At step 403, if the stream is not a scalable video encoded stream, the receiving device may then decode the stream.

At step 404, if the stream is a scalable video encoded stream, the receiving device sends the scalable video encoded stream to the transcoding device 130d.

At step 405, the receiving device receives a single layer encoded video stream from the transcoding device 130d. For example, the transcoding device 130d generates the single layer encoded video stream from the scalable video coded stream based on coding parameters. The STB 120d may send the coding parameters to the transcoding device 130d or the coding parameters may have been previously stored in the transcoding device. The coding parameters may indicate a level of quality, a resolution (e.g., 720 P, 1080 P, etc.), a coding standard (e.g., MPEG-2, MPEG-4 AVC, etc.), and other parameters that describe the single layer encoded video stream to be generated. The single layer encoded video stream is sent to the STB 120d.

At step 406, the receiving device decodes the received single layer encoded video stream, and the decoded video stream may be sent to a TV or another display device.

As described above with respect to FIG. 3, in another embodiment, the decoding device 301 connected to the receiving device decodes the scalable video coded stream instead of sending a single layer encoded video stream back to the receiving device. In this embodiment, the receiving device may receive the decoded stream from the decoding device or the decoding device sends the decoded stream to another device.

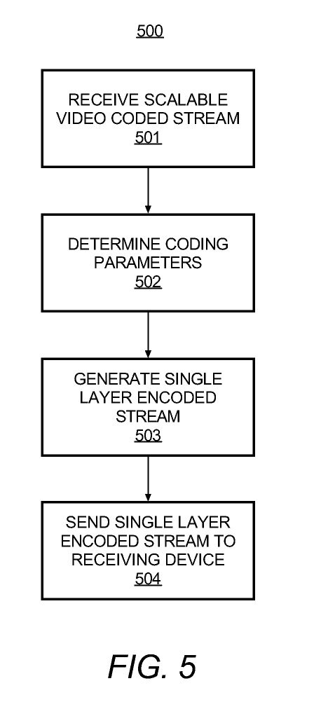

FIG. 5 illustrates a flowchart of a method 500 performed by a transcoding device connected to a receiving device, according to an embodiment. The method 500 may be described with respect to FIGS. 1-3 by way of example and not limitation. Also, the steps of the method 500 may be performed after step 402 if the receiving device determines the input stream includes a scalable video coded stream.

At step 501, the transcoding device 301 receives the scalable video coded stream from the receiving device.

At step 502, the transcoding device 301 determines coding parameters for a single layer video encoded stream to be generated. The coding parameters may be sent by the receiving device or previously stored in the transcoding device 301.

At step 503, the transcoding device 301 generates the single layer video encoded stream based on the coding parameters.

At step 504, the transcoding device 301 sends the single layer video encoded stream to the receiving device. Then, at step 405, the receiving device receives the single layer encoded video stream and decodes the stream at step 406 described with respect to the method 400.

Through the methods 400 and 500, legacy STBs at the subscribers' premises can utilize scalable video coded streams even if their STBs do not have the capability to decode scalable video coded streams.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims and their equivalents in which all terms are mean in their broadest reasonable sense unless otherwise indicated.

What is claimed is:

1. A transcoding device configured to transcode a scalable video coded stream to a single layer encoded video stream, the transcoding device comprising:
an interface connecting a receiving device to the transcoding device, wherein the receiving device is configured to receive an encoded video stream and determine whether the encoded video stream includes a scalable video coded stream; and
a transcoder receiving the scalable video coded stream via the interface from the receiving device in response to the receiving device determining the encoded video stream includes the scalable video coded stream, and
the transcoder generating a single layer encoded video stream from the scalable video coded stream based on coding parameters describing parameters of a single layer encoded video stream to be generated by the transcoder, wherein
the single layer encoded video stream is sent to the receiving device via the interface.

2. The transcoding device of claim 1, wherein the transcoder determines the coding parameters from a control signal received via the interface from the receiving device.

3. The transcoding device of claim 1, wherein the coding parameters include at least one of a resolution, a level of quality, and an encoding standard for the single layer encoded video stream.

4. The transcoding device of claim 1, wherein the interface comprises a USB or Ethernet interface.

5. The transcoding device of claim 1, wherein the receiving device is a set top box.

6. The transcoding device of claim 1, wherein the receiving device is configured to decode the single layer encoded video stream.

7. The transcoding device of claim 1, wherein the receiving device is not capable of decoding the scalable video coded stream.

8. The transcoding device of claim 1, wherein the transcoding device is external to the receiving device.

9. The transcoding device of claim 1, wherein the encoded scalable video stream and the encoded single layer video stream are MPEG streams.

10. The transcoding device of claim 1, wherein the receiving device is configured to receive the encoded scalable video stream via a communications network.

11. A decoding device configured to decode a scalable video coded stream received from a receiving device having a legacy decoding device, the decoding device comprising:
an interface connecting the receiving device to the decoding device, wherein the decoding device is in a housing external to a second housing containing the receiving device and the receiving device is configured to receive an encoded video stream and determine whether the encoded video stream includes a scalable video coded stream; and
a decoder receiving the scalable video coded stream via the interface from the receiving device in response to the receiving device determining the encoded video stream includes the scalable video coded stream, and
the decoder decoding the scalable video coded stream based on coding parameters, wherein
the decoding device is configured to output the decoded video stream to the receiving device or another device connected to the receiving device via a second interface.

12. The decoding device of claim 11, wherein the decoder determines the coding parameters from a control signal received via the interface from the receiving device.

13. The decoding device of claim 11, wherein the coding parameters include at least one of a resolution, and a level of quality for the decoded video stream.

14. The decoding device of claim 11, wherein the interface comprises a USB or Ethernet interface.

15. The decoding device of claim 11, wherein the receiving device is a set top box.

16. The decoding device of claim 11, wherein the decoding device is external to the receiving device.

17. A receiving device comprising:
a first interface configured to receive an MPEG stream via a communications network;
a second interface configured to provide a connection to an external transcoding device;
a processor configured to determine whether the MPEG stream includes a scalable video coded stream, and in response to determining the MPEG stream includes a scalable video coded stream, the processor sending the scalable video coded stream to the external transcoding device via the second interface, wherein the transcoding device is configured to generate a single layer encoded MPEG video stream from the scalable video coded stream based on coding parameters; and
a decoder configured to decode the single layer encoded video stream, wherein the single layer encoded video stream is received from the external transcoding device via the second interface.

18. The receiving device of claim 17, wherein the processor is configured to send a control signal including the coding parameters to the transcoding device via the second interface.

19. The receiving device of claim 17, wherein the receiving device is a set top box.

20. A method of generating a single layer encoded video stream from a scalable video coded stream for a receiving device, the method comprising:
receiving, at a receiving device, an MPEG stream via a communications network;
determining whether the MPEG stream includes a scalable video coded stream;
in response to determining the MPEG stream includes a scalable video coded stream, sending the scalable video coded stream to an external transcoding device connected to the receiving device via an interface, wherein the transcoding device is configured to generate a single layer encoded MPEG video stream from the scalable video coded stream based on coding parameters;
receiving the single layer encoded MPEG video stream from the transcoding device via the interface; and
decoding the single layer encoded video stream.
